(19) United States
(12) Patent Application Publication
(10) Pub. No.: US 2005/0259749 A1
(43) Pub. Date: Nov. 24, 2005

(54) Motion picture coding method and apparatus

(76) Inventors: Takahiro Yamamoto, Osaka (JP); Shinji Kitamura, Nagaokakyo-shi (JP)

Correspondence Address: MCDERMOTT WILL & EMERY LLP, 600 13TH STREET, N.W., WASHINGTON, DC, 20005-3096, US

(21) Appl. No.: 11/131,337

(22) Filed: May 18, 2005

(30) Foreign Application Priority Data
May 18, 2004 (JP) P2004-147280

(51) Int. Cl. H04N 7/12

(52) U.S. Cl. 375/240.25; 375/240.01

(57) ABSTRACT

Communications means is provided to enable two pieces of motion picture coding apparatus, placed oppositely so that capacities of reference image memories needed for decoding can be detected in advance, to exchange capacity control information of the reference memories. The respective pieces of motion picture coding apparatus are configured in such a manner that memory capacities are sharable between the reference image memories for encoding and the reference image memories for decoding, and a capacity of the reference image memory for encoding is determined depending on a capacity of the reference image memory for decoding. It is thus possible to reduce capacities of the reference image memories for encoding and the reference image memories for decoding to be equal to or smaller than a capacity defined in the two-way motion picture communication system.

This application is based on Japanese Patent Application No. 2004-147280, which is incorporated herein by reference.

### BACKGROUND OF THE INVENTION

1. Field of the Invention

The present invention relates to motion picture coding method and apparatus in a two-way communication system using motion picture compression coding techniques, such as MPEG, and more particularly, to a technique for making it possible to reduce a capacity of a reference image memory in the motion picture coding.

2. Description of the Related Art

FIG. 13 is a view used to describe a use method of reference image memories in a two-way motion picture communication in the related art. Referring to FIG. 13, numeral 301 denotes a motion picture coding apparatus in a local station, numeral 302 denotes a reference image memory used when a transmission image is encoded in the local station, numeral 303 denotes a reference image memory used when a reception image is decoded in the local station, numeral 304 denotes a motion picture coding apparatus in a remote station, numeral 305 denotes a reference image memory used when a reception image is decoded in the remote station, and numeral 306 denotes a reference image memory used when a transmission image is encoded in the remote station.

Further, numeral 308 denotes encoded data (bit stream) distributed to the motion picture coding apparatus 304 in the remote station from the motion picture coding apparatus 301 in the local station, and numeral 307 denotes encoded data (bit stream) distributed to the motion picture coding apparatus 301 in the local station from the motion picture coding apparatus 304 in the remote station.

In this manner, in each of the local station and the remote station, reference image memories having a two frames' worth of capacity is necessary to encode and decode a motion picture. The predicting coding method using a reference image is the basis of the motion picture compression coding technique. Because a more complicated prediction coding method, such as two-way predicting encoding, is used to encode motion pictures in TV broadcasting or the like, extensive efforts are being made to manage more efficiently a buffer memory, which has been used as the reference image memory in the related art (for example, see JP-A-11-313327)

Because a technique for achieving a high compression rate, such as MPEG-4, has been developed, the motion picture coding techniques have enabled a two-way motion picture communication, which in turn enables a two-way motion picture communication in an expensive system, such as a TV conference system. However, there has been an increasing need for a two-way motion picture communication system using a compact, inexpensive, and portable mobile system represented by a cellular phone with camera.

Under these circumstances, besides using the buffer memory efficiently by the technique disclosed in JP-A-11-313327, a chip area, that is, the reference image memory (frame memory) reflecting the cost, may be reduced directly in order to save the cost and reduce the size of an encoding device (encoder) installed in a mobile device or the like. Reducing a capacity of the reference image memory, however, limits the predicting coding, which is the basis of the techniques. Hence, when a capacity of the reference image memory in the encoder is reduced, coding efficiency is deteriorated, which causes an increase in coding volume.

According to a technique in Japanese Patent Application No. 2003-057199 (hereinafter, referred to as the precedent application art), the need to prepare reference images for all macro blocks in a current frame in the encoder can be eliminated by deciding the macro block positions, at which intra-encoding or inter-encoding is performed, when a preceding image of the current image is encoded. It is thus possible to reduce a capacity of the reference image memory in the encoder while maintaining the coding efficiency and the image quality that suit the purpose of use, which can in turn save the cost of the encoder.

FIG. 14 is a block diagram showing the configuration of the encoder according to the precedent application art. Referring to FIG. 14, numeral 101 denotes an image input portion, numeral 103 denotes a DCT portion that performs orthogonal transformation, numeral 104 denotes a quantization portion, numeral 105 denotes a variable-length coding portion that performs compression coding, numeral 106 denotes an inverse quantization portion, numeral 107 denotes an inverse DCT portion, numeral 108 denotes a reference image memory, numeral 109 denotes a motion compensation portion, numeral 110 denotes a motion detection portion, and numeral 111 denotes a memory control portion.

In the memory control portion 111, the maximum number of macro blocks to be inter-encoded within one image frame is set to a value smaller than the number of macro blocks forming the image frame, and the macro block positions at which inter-encoding is performed in the following frame are determined to fall within the pre-set maximum number of macro blocks. When configured in this manner, the reference image memory is not necessarily a frame memory to record reference images of the entire one image frame, and can be therefore formed to have only a capacity needed for the maximum number of macro blocks to be inter-encoded.

FIG. 14 schematically shows a manner in which the memory control portion 111 performs recording control to record only macro blocks at the macro block positions to be inter-encoded in the following frame into the reference image memory 108 by a switching function SW.

FIG. 15 is a view used to describe a manner of the recording control on the reference image memory in the encoder. Referring to FIG. 15, a motion picture is a CIF image (macro blocks: 22×18), and the intra-encoded micro blocks and inter-encoded microblocks each account for 50%. The left half of the frame (screen) shows the layout of macro blocks 201 at the macro block positions to be intra-encoded, and the right half of the frame (image) shows the layout of macro blocks 202 at the macro block positions to be inter-encoded.

Because the reference image memory 108 records only a reference image macro block group 203 at the macro block positions to be inter-encoded in the following frame, a capacity of the reference image memory 108 can be half the capacity of the frame memory 204 in the related art that is capable of recording reference images at all the macro block positions.

More compact and inexpensive encoder and decoder are becoming more crucial in order to perform a two-way motion picture communication in a compact and inexpensive mobile system, such as a cellular phone with camera, and a problem that needs to be solved is a reduction in capacity of an image memory, which has been the bottleneck in achieving a reduction in size and cost.

Even when the means disclosed in the precedent application art is adopted in the encoder, the decoding device (decoder) to decode a reception image needs a reference image memory having a one frame's worth of capacity. Hence, the encoder and the decoder need a memory capacity of approximately two frame's worth in total. Because a mobile device, such as a cellular phone, also needs an inexpensive and compact decoder, a capacity of the reference image memory needs to be reduced further in a codec that achieves both the encoder and the decoder concurrently.

### SUMMARY OF THE INVENTION

An object of the invention is therefore to provide motion picture coding method and apparatus in a two-way motion picture communication system using motion picture compression coding techniques, such as MPEG, which are capable of reducing a capacity of a reference image memory used in a codec that achieves both the encoder and the decoder concurrently to be equal to or smaller than a capacity defined in a system performing a two-way motion picture communication.

A motion picture coding method of the invention is a motion picture coding method in a system performing a two-way motion picture communication comprising placing oppositely two pieces of motion picture coding apparatus that encode and decode a motion picture by a motion picture compression coding method using reference image memories constructed in such a manner that memory capacities are sharable between a reference image memory used for encoding and a reference image memory used for decoding, and determining a capacity of the reference image memory used for encoding depending on a capacity of the reference image memory used for decoding. In the invention, oppositely placed first and second pieces of motion picture coding apparatus exchange capacity control information of the reference image memory each piece uses.

According to this configuration, a capacity of the reference image memory needed for decoding can be detected in advance using communications means for exchanging capacity control information of the reference image memories, and the reference image memory used for encoding and the reference image memory used for decoding are constructed in such a manner that they can share memory capacities. Hence, even when a capacity of the reference image memory is reduced to be equal to or smaller than the capacity defined in the two-way motion picture communication system, it is possible to secure a capacity needed for decoding in the reference image memory that the decoder uses while limiting a capacity of the reference image memory for encoding that the encoder uses. It is thus possible to maintain a two-way motion picture communication even when a capacity of the reference image memory is reduced, although limitations are imposed to some extent.

In the invention, the capacity control information is exchanged using user information embedded in a bit stream of encoded data of a motion picture. According to this configuration, because the user information embedded in the bit stream of encoded data of a motion picture defined by MPEG or the like is used, it is possible to achieve communications means for exchanging capacity control information of the reference image memories while maintaining the processing procedure of a normal two-way motion picture communication and the compatibility of the encoded data of a motion picture.

In the invention, the capacity control information of the reference image memory is control information allowing the second piece of motion picture coding apparatus to detect, in advance, a capacity of the reference image memory that the first piece of motion picture coding apparatus uses for encoding.

In the invention, in a case where the capacity of the reference image memory that the first piece of motion picture coding apparatus uses for encoding is detectable in advance, a capacity of the reference image memory that the second piece of motion picture coding apparatus uses for decoding is set equal to the capacity of the reference image memory that the first piece of motion picture coding apparatus uses for encoding. According to this configuration, for example, in a two-way motion picture communication system in which a memory capacity of the reference image memory is set to be one frame's worth, when the oppositely placed pieces of the motion picture coding apparatus reduce a capacity of the reference image memory for the encoder to ½ frame's worth in each using the precedent application art, because it is possible to detect in advance that a capacity of the reference image memory needed for decoding is ½ frame's worth from the capacity control information of the reference image memory, a capacity of the reference image for decoding can be reduced to ½ frame's worth, too. Hence, a total of one frame's worth of capacity can be reduced from the reference image memories for the encoder and the decoder. That is to say, it is possible to construct a two-way motion picture communication system by placing oppositely two pieces of motion picture coding apparatus, each having reference image memories having a ½ frame's worth of capacity for the encoder and for the decoder.

In the invention, in a case where the capacity of the reference image memory that the first piece of motion picture coding apparatus uses for encoding is undetectable in advance, a capacity of the reference image memory that the second piece of motion picture coding apparatus uses for decoding is set equal to a capacity of the reference image memory defined in the system performing the two-way motion picture communication. According to this configuration, for example, in a two-way motion picture communication system in which a capacity of the reference image memory is defined to be one frame's worth, when a local station in which capacities of the reference image memories for the encoder and the decoder are reduced to ½ frame's worth in each is to make a communication with a remote station using a motion picture coding apparatus in the related art (an apparatus that does not correspond to special encoding and decoding using reference image memories having reduced capacities, and hereinafter, referred to as the motion picture coding apparatus in the related art), because the capacity control information of the reference image memory cannot be obtained, a capacity of the reference image memory that the remote station uses for encoding is undetectable. This makes it necessary to secure a one frame's worth of capacity, defined in the two-way motion picture communication system, as a capacity of the reference image memory needed for decoding. However, because the reference image memory used for encoding can be used as the reference image memory used for decoding in the remote station, a capacity of the reference image memory used for decoding can be secured. Herein, only a one-way communication is enabled because the encoder is unusable. However, it is possible to maintain a motion picture communication with the remote station using the motion picture coding apparatus in the related art.

In the invention, the capacity control information of the reference image memory is control information allowing the second piece of motion picture coding apparatus to detect, in advance, a capacity of the reference image memory that the first piece of motion picture coding apparatus uses for decoding. Also, in the invention, in a case where the capacity of the reference image memory that the first piece of motion picture coding apparatus uses for decoding is detectable in advance, a capacity of the reference image memory that the second piece of motion picture coding apparatus uses for encoding is set equal to the capacity of the reference image memory that the first piece of motion picture coding apparatus uses for decoding.

In the two-way motion picture communication system, when the local station performs encoding using the reference image memory having a capacity exceeding a capacity of the reference image memory that the remote station uses for decoding, the remote state is unable to decode a motion picture, and such an event has to be avoided. According to the method, when two pieces of motion picture coding apparatus of the invention are placed oppositely, the local station is able to detect, in advance, a capacity of the reference image memory that the remote station uses for decoding. This makes it possible to set a capacity of the reference image memory that the local station uses for encoding equal to the capacity of the reference image memory that the remote station uses for decoding. It is thus possible to set capacities of the reference image memories for the encoder and the decoder to be smaller than corresponding capacities of the reference image memories defined in the two-way motion picture communication system. Hence, for example, in a two-way motion picture communication system, in which a capacity of the reference image memory is defined to be one frame's worth, the system can be constructed using a motion picture coding apparatus in which capacities of the reference image memories for the encoder and the decoder are reduced to ½ frame's worth in each. A total of one frame's worth of capacity can be thereby reduced from the reference image memories for the encoder and the decoder.

In the invention, in a case where the capacity of the reference image memory that the first piece of motion picture coding apparatus uses for decoding is undetectable in advance, a capacity of the reference image memory that the second piece of motion picture coding apparatus uses for encoding is set equal to a capacity of the reference image memory defined in the system performing the two-way motion picture communication. According to this configuration, for example, in a two-way motion picture communication system, in which a capacity of the reference image memory is defined to be one frame's worth, when a local station in which capacities of the reference image memories for the encoder and the decoder are reduced to ½ frame's worth in each is to make a communication with a remote station using the motion picture coding apparatus in the related art, because the capacity control information of the reference image memory cannot be obtained, a capacity of the reference image memory that the remote station uses for decoding is undetectable. Hence, it is judged that the remote station is the motion picture coding apparatus in the related art and uses a reference image memory having a one frame's worth of capacity for encoding. In this case, a capacity of the reference image memory for the encoder may be left intact to be ½ frame's worth, but only a one-way communication is enabled anyway, because the encoder and the decoder cannot be used concurrently as the reference image memory used for decoding is used as the reference image memory used for encoding. However, it is still possible to improve the image quality of a transmission image.

In the invention, a capacity of the reference image memory used for encoding or decoding is set in advance from an outside. According to this configuration, for example, when the user of a mobile device wishes to improve the image quality of a motion picture depending on the communication situation, the user is able to control the image quality of a motion picture by specifying a capacity of the reference image memory used for encoding or decoding by manipulating the mobile device.

In the invention, in a case where a capacity of the reference image memory used for encoding or decoding is set to a capacity smaller than a memory capacity usable as the reference image memory, an available memory capacity in the usable memory capacity as the reference image memory is used for another purpose other than the reference image memory.

According to this configuration, although the image quality is deteriorated because an encoding volume of encoded data of a motion picture is increased with a decrease of a capacity of the reference image memory, a memory made available by reducing a capacity of the reference image memory can be used for various purposes. This can reduce a total memory capacity that the entire apparatus uses.

In the invention, the available memory capacity in the usable memory capacity as the reference image memory is used for encoding and decoding audios. According to this configuration, capacities of the reference image memories and the audio memories can be set flexibly to best suit the system configuration and the purpose of use. When processing by the audio codec is not needed, a memory allocated to the audio memory can be re-allocated back to the original reference image memory. Also, when the priority is placed on audios rather than the image quality, it is possible to further reduce a capacity of the reference image memory. It is thus possible to reduce efficiently a total memory capacity that the entire apparatus uses.

In the invention, the capacity control information of the reference image memory is control information allowing the first piece of motion picture coding apparatus to make a request to the second piece of motion picture coding apparatus to increase or decrease a capacity of the reference image memory used for encoding, or control information allowing the first piece of motion picture coding apparatus to make a request to the second piece of motion picture coding apparatus to restore the increased or decreased capacity of the reference image memory to a capacity before the capacity was increased or decreased. Also, in the invention, the control information requesting to increase or decrease the capacity of the reference image memory used for encoding, or the control information requesting to restore the increased or decreased capacity of the reference image memory to a capacity before the capacity was increased or decreased is transmitted in the form of a manipulation signal from an outside in the first piece of motion picture coding apparatus. According to this configuration, when the user wishes to improve the image quality of a motion picture received at the local station from the remote station in a two-way motion picture communication system, as the user manipulates the pieces of apparatus serving as the local station and the remote station, both a capacity of the reference image memory for the encoder in the remote station and a capacity of the reference image memory for the decoder in the local station can be increased. It is thus possible to improve the image quality of a motion picture received from the remote station temporarily until capacities are restored to the original capacities. Conversely, when the user wishes to reduce a capacity of the reference image memory needed to decode a motion picture received at the local station from the remote station, as the user manipulates the pieces of apparatus serving as the local station and the remote station, both a capacity of the reference image memory for the encoder in the remote station and a capacity of the reference image memory for the decoder in the local station can be reduced. It is thus possible to reduce capacities of the reference image memories needed to decode a motion picture received from the remote station temporarily until capacities are restored to the original capacities.

In the invention, the control information requesting to increase the capacity of the reference image memory used for encoding, or the control information requesting to restore the increased capacity of the reference image memory to a capacity before the capacity was increased is transmitted when an encoding volume of encoded data to be received at the first piece of motion picture coding apparatus exceeds a predetermined value. According to this configuration, when an encoding volume of encoded data to be received exceeds a predetermined value, both a capacity of the reference image memory in the encoder in the remote station and a capacity of the reference image memory in the decoder in the local station can be increased. It is thus possible to improve the image quality of a motion picture received from the remote station temporarily until capacities of the reference image memories are restored to the original capacities against deterioration of the image quality caused when an encoding volume exceeds a communication capacity.

In the invention, the control information requesting to increase the capacity of the reference image memory used for encoding, or the control information requesting to restore the increased capacity of the reference image memory to a capacity before the capacity was increased is transmitted when an encoding volume of encoded data to be received at the first piece of motion picture coding apparatus keeps exceeding a predetermined value for a predetermined number of plural frames. According to this configuration, when it is observed that an encoding volume of encoded data to be received keeps exceeding a predetermined value for a predetermined number of plural frames, both a capacity of the reference image memory in the encoder in the remote station and a capacity of the reference image memory in the decoder in the local station can be increased. It is thus possible to improve the image quality of a motion picture received from the remote station temporarily until capacities of the reference image memories are restored to the original capacities when the image quality is kept deteriorated over some time as an encoding volume exceeds a communication capacity. By performing the control in this manner, it is possible to avoid an event such that the image quality changes abruptly or the burdens are imposed on the system by immediately responding to an abrupt change of an encoding volume caused by an abrupt change of screens, such as a scene change.

In the invention, the capacity control information of the reference image memory is control information allowing the first piece of motion picture coding apparatus to make a request to the second piece of motion picture coding apparatus to increase or decrease a capacity of the reference image memory used for decoding, or control information allowing the first piece of motion picture coding apparatus to make a request to the second piece of motion picture coding apparatus to restore the increased or decreased capacity of the reference image memory to a capacity before the capacity was increased or decreased.

In the invention, the control information requesting to increase or reduce the capacity of the reference image memory used for decoding, or the control information requesting to restore the increased or decreased capacity of the reference image memory to a capacity before the capacity was increased or decreased is transmitted in the form of a manipulation signal from an outside in the first piece of motion picture coding apparatus. According to this configuration, when the user wishes to improve the image quality of a motion picture transmitted to the remote station from the local station in a two-way motion picture communication system, as the user manipulates the pieces of apparatus serving as the local station and the remote station, both a capacity of the reference image memory for the decoder in the remote station and a capacity of the reference image memory for the encoder in the local station can be increased. It is thus possible to improve the image quality of a motion picture transmitted to the remote station temporarily until capacities are restored to the original capacities. Conversely, when the user wishes to reduce a capacity of the reference image memory needed to decode a motion picture received at the local station from the remote station, as the user manipulates the pieces of apparatus serving as the local station and the remote station, both a capacity of the reference image memory for the encoder in the remote station and a capacity of the reference image memory for the decoder in the local station can be reduced. It is thus possible to reduce capacities of the reference image memories needed to decode a motion picture received from the remote station temporarily until capacities are restored to the original capacities.

In the invention, the control information requesting to increase the capacity of the reference image memory used for decoding, or the control information requesting to restore the increased capacity of the reference image memory to a capacity before the capacity was increased is transmitted when an encoding volume of encoded data to be transmitted from the first piece of motion picture coding apparatus exceeds a predetermined value. According to this configuration, when an encoding volume of encoded data to be transmitted exceeds a predetermined value, both a capacity of the reference image memory in the decoder in the remote station and a capacity of the reference image memory in the encoder in the local station can be increased. It is thus possible to improve the image quality of a motion picture transmitted to the remote station temporarily until capacities of the reference image memories are restored to the original capacities against deterioration of the image quality caused when an encoding volume exceeds a communication capacity.

In the invention, the control information requesting to increase the capacity of the reference image memory used for decoding, or the control information requesting to restore the increased capacity of the reference image memory to a capacity before the capacity was increased is transmitted when an encoding volume of encoded data to be transmitted from the first piece of motion picture coding apparatus keeps exceeding a predetermined value for a predetermined number of plural frames. According to this configuration, when it is observed that an encoding volume of encoded data to be transmitted keeps exceeding a predetermined value for a predetermined number of plural frames, both a capacity of the reference image memory in the decoder in the remote station and a capacity of the reference image memory in the encoder in the local station can be increased. It is thus possible to improve the image quality of a motion picture to be transmitted to the remote station temporarily until capacities of the reference image memories are restored to the original capacities when the image quality is kept deteriorated over some time as an encoding volume exceeds a communication capacity. By performing the control in this manner, it is possible to avoid an event such that the image quality changes abruptly or the burdens are imposed on the system by immediately responding to an abrupt change of an encoding volume caused by an abrupt change of screens, such as a scene change.

A motion picture coding apparatus of the invention is a motion picture coding apparatus, two pieces of which are placed oppositely to encode and decode a motion picture in a system performing a two-way motion picture communication by a motion picture compression coding method using reference image memories, wherein: a reference image memory used for encoding and a reference image memory used for decoding are constructed as a common memory whose memory capacity is sharable; the apparatus is controlled in such a manner that a capacity of the reference image memory used for decoding is allocated with a higher priority than a capacity of the reference image memory used for encoding; and the apparatus is provided with communications means formed of transmission of a request and a transmission of a response to the request for enabling the oppositely placed two pieces of motion picture coding apparatus to exchange capacity control information of the reference image memory each piece uses. According to this configuration, a capacity of the reference image memory needed for decoding can be detected in advance using the communications means for exchanging capacity control information of the reference image memories, and the reference image memory used for encoding and the reference image memory used for decoding are constructed in such a manner that they can share memory capacities. Hence, even when a capacity of the reference image memory is reduced to be equal to or smaller than the capacity defined in the two-way motion picture communication system, it is possible to secure a capacity needed for decoding in the reference image memory that the decoder uses while limiting a capacity of the reference image memory for encoding that the encoder uses. It is thus possible to maintain a two-way motion picture communication even when a capacity of the reference image memory is reduced, although some limitations are imposed.

In the invention, the apparatus is provided with an encoding volume counter that observes an encoding volume of encoded data to be received or an encoding volume of encoded data to be transmitted. Also, in the invention, whether the encoding volume counter observes the encoding volume of encoded data is set from an outside, and the encoding volume counter is deactivated when set not to observe the encoding volume. According to this configuration, it is possible to select whether an encoding volume of encoded data is observed; moreover, the encoding volume counter can be deactivated when an encoding volume is not observed. This configuration can contribute to a power saving when the motion picture coding apparatus is installed in a mobile device or the like.

In the invention, each of a capacity of the reference image memory used for encoding and a capacity of the reference image memory used for decoding is a capacity equal to or smaller than a memory capacity needed to store one frame of a reference image.

In the invention, each of a capacity of the reference image memory used for encoding and a capacity of the reference image memory used for decoding is divided into an equal number of plural sets, so that the apparatus functions as plural sets of motion picture coding apparatus. According to this configuration, although the image quality is deteriorated because an encoding volume of encoded data of a motion picture is increased with a decrease of capacities of the reference image memories, it is possible to achieve a multi-codec of a two-way motion picture communication without increasing a total memory capacity that the entire apparatus uses.

In the invention, when a partial or entire region in the reference image memory is detected to be unused, the apparatus performs control in such a manner that the unused region is deactivated dynamically. According to this configuration, because the unused region in the reference image memory can be deactivated dynamically, power consumption can be saved efficiently. This configuration can therefore contribute to a power saving when the motion picture coding apparatus is installed in a mobile device or the like.

According to the invention, in a two-way motion picture communication system, capacities of the reference image memories that the motion picture coding apparatus needs can be detected in advance, and by sharing memory capacities between the reference image memory used for encoding and the reference image memory used for decoding, it is possible to reduce capacities of the reference image memories to a capacity equal to or smaller than a capacity defined in the system performing a two-way motion picture communication. In addition, by utilizing a capacity of the reference image memory made available in this manner for another purpose, the system cost can be saved by reducing a total memory capacity of the entire system. It is thus possible to achieve an inexpensive and compact two-way motion picture communication system.

### BRIEF DESCRIPTION OF THE DRAWINGS

FIG. 1 is a block diagram showing the configuration of a motion picture coding apparatus according to a first embodiment of the invention;

FIG. 2 is a view showing a coding method in a user region defined by the MPEG standards;

FIG. 3 is a view used to describe a use method of reference image memories in the first embodiment of the invention;

FIGS. 4A and 4B are views used to describe a use method of reference image memories when a motion picture coding apparatus according to the first embodiment of the invention and a motion picture coding apparatus in the related art make a motion picture communication;

FIG. 5 is a view used to describe a use method of reference image memories and audio memories according to a second embodiment of the invention;

FIGS. 6A to 6C are views used to describe a use method of reference image memories when it is judged that the image quality needs to be improved at the transmitter's end according to a third embodiment of the invention;

FIGS. 7A to 7C are views used to describe a use method of reference image memories when it is judged that the image quality needs to be improved at the receiver's end according to the third embodiment of the invention;

FIGS. 8A to 8C are views used to describe a use method of reference image memories when the image quality is improved to the maximum level at the transmitter's end according to the third embodiment of the invention;

FIG. 9 is a view used to describe a use method of reference image memories when a motion picture communication is made with the remote station in the related art adopting an image smaller than an image in the local station according to the third embodiment;

FIGS. 10A to 10C are views used to describe a method of controlling reference image memories depending on an encoding volume at the transmitter's end according to a fourth embodiment of the invention;

FIGS. 11A to 11C are views used to describe a method of controlling reference image memories depending on an encoding volume at the receiver's end according to the fourth embodiment of the invention;

FIG. 12 is a view used to describe a use method of reference image memories in a multi-codec of a motion picture according to the second embodiment of the invention.

FIG. 13 is a view used to describe a use method of reference image memories in a two-way motion picture communication in the related art;

FIG. 14 is a block diagram showing the configuration of an encoder disclosed in the precedent application art; and

FIG. 15 is a view used to describe a manner of recording control on reference image memories by the encoder disclosed in the precedent application art.

### DETAILED DESCRIPTION OF THE PREFERRED EMBODIMENTS

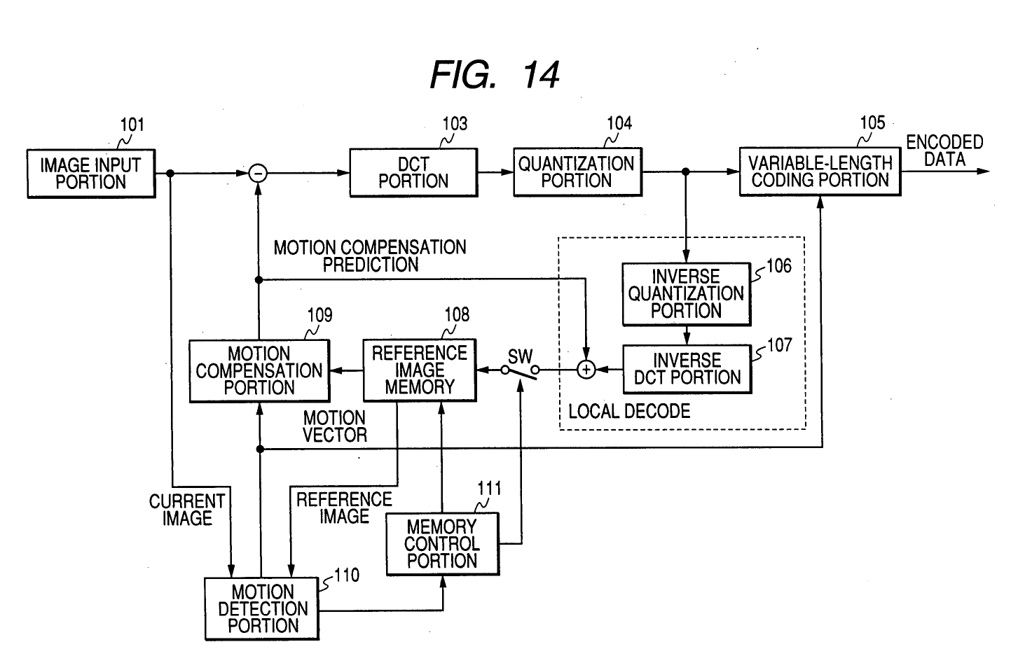

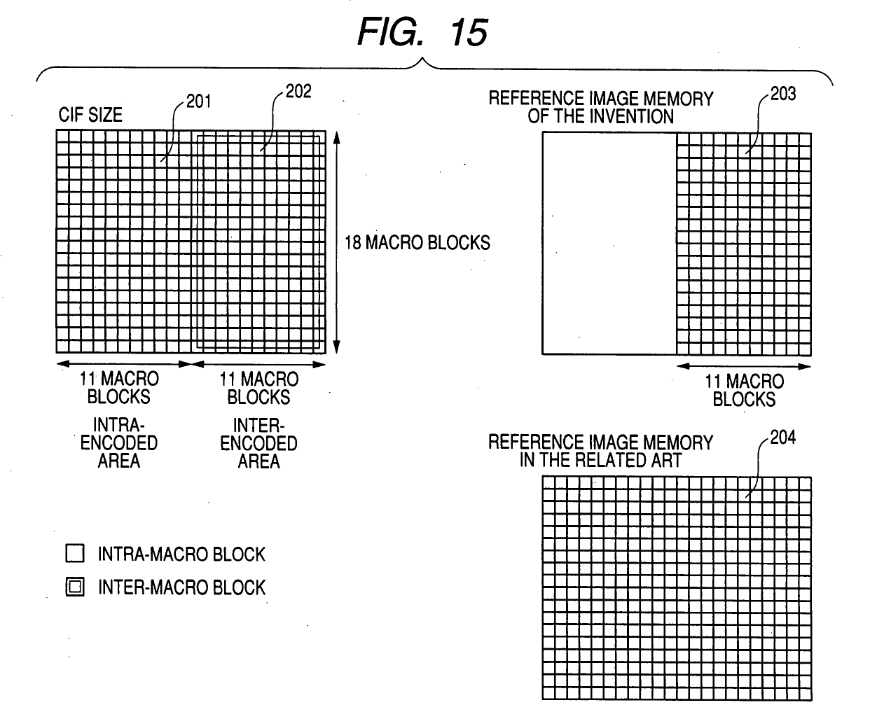

Hereinafter, embodiments of the invention will be described with reference to the drawings. In the drawings, identical or like portions are labeled with identical or like reference numerals, and descriptions of the identical portions are not repeated herein. The same can be said for the same portions in FIG. 13 and FIG. 14.

In the embodiments described below, descriptions will be given on the assumption that capacities of reference image memories used for encoding and decoding a motion picture are set to half (½) the memory capacity of one frame's worth. It should be appreciated, however, that a capacity can be set to an arbitrary capacity smaller than the memory capacity of one frame's worth, and the invention is not limited to the embodiments below.

Also, in the embodiments described below, “a local station” and “a remote station” are terms used for ease of explanation to discriminate two stations making a two-way communication, and there is no intention to specify which of the two stations dominates the control of the invention.

### First Embodiment

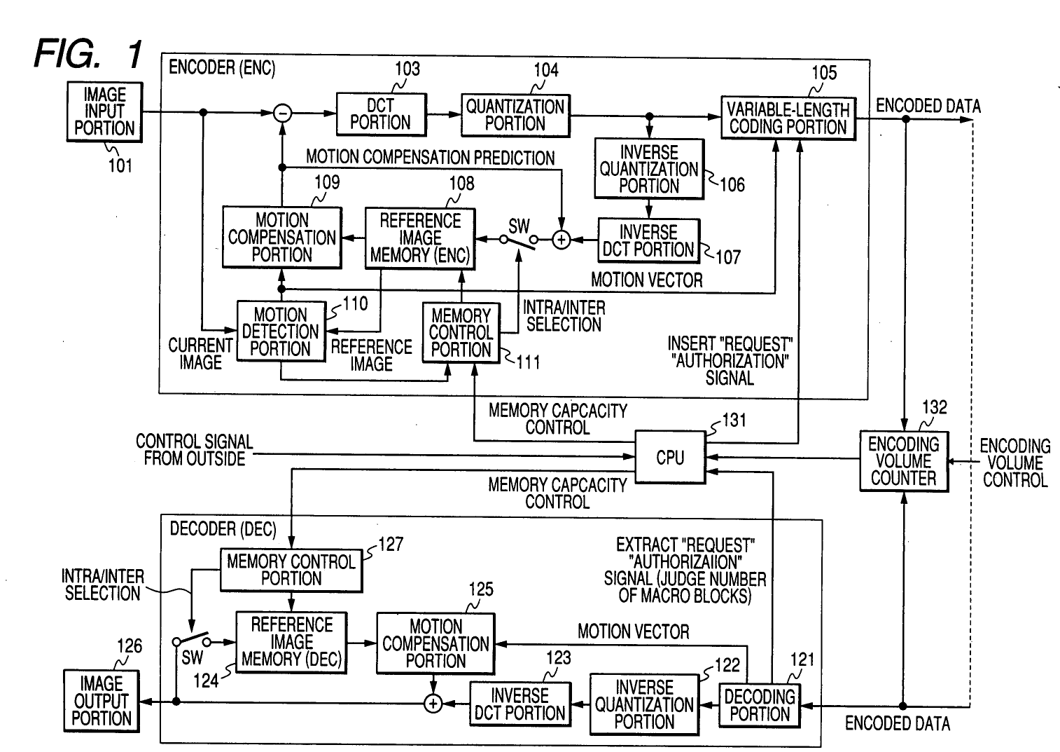

FIG. 1 is a block diagram showing the configuration of a motion picture coding apparatus according to a first embodiment of the invention. The motion picture coding apparatus comprises an encoder that performs compression coding of a motion picture, a decoder that decodes encoded data to render a motion picture, a CPU 131 that controls the entire apparatus, etc.

In the encoder shown in FIG. 1, numeral 101 denotes an image input portion, numeral 103 denotes a DCT portion that performs orthogonal transformation, numeral 104 denotes a quantization portion, numeral 105 denotes a variable-length coding portion that performs compression coding, numeral 106 denotes an inverse quantization portion, numeral 107 denotes an inverse DCT portion that performs inverse orthogonal transformation, numeral 108 denotes a reference image memory, numeral 109 denotes a motion compensation portion, numeral 110 denotes a motion detection portion, and numeral 111 denotes a memory control portion.

In the encoder, only macro blocks at macro block positions to be inter-encoded in the following frame are recorded in the reference image memory 108. The memory control portion 111 performs recording control for this recording to take place, and a manner of this control is schematically shown by a switch function SW.

In the decoder shown in FIG. 1, numeral 121 denotes a decoding portion that decodes encoded data, numeral 122 denotes an inverse quantization portion, numeral 123 denotes an inverse DCT portion that performs inverse orthogonal transformation, numeral 124 denotes a reference image memory, numeral 125 denotes a motion compensation portion, numeral 126 denotes an image output portion, and numeral 127 denotes a memory control portion.

The configuration described above is the configuration of known encoder and decoder in a two-way motion picture communication system using motion picture compressing coding techniques, such as MPEG, except for the memory control portion 111 and the switch function SW in the encoder and the memory control portion 127 in the decoder.

By using the memory control portion 111 and the switching function SW by the method in the precedent application art, the encoder is able to perform encoding by reducing a capacity of the reference image memory, which needs to be one frame's worth in the related art, to, for example, ½ frame's worth.

In a case where the decoder is able to receive, in advance, from the encoder information indicating that only a ½ frame's worth of capacity in the reference image memory is used, the decoder is able to perform decoding by reducing a capacity of the reference image memory, which needs to be one frame's worth, to ½ frame's worth.

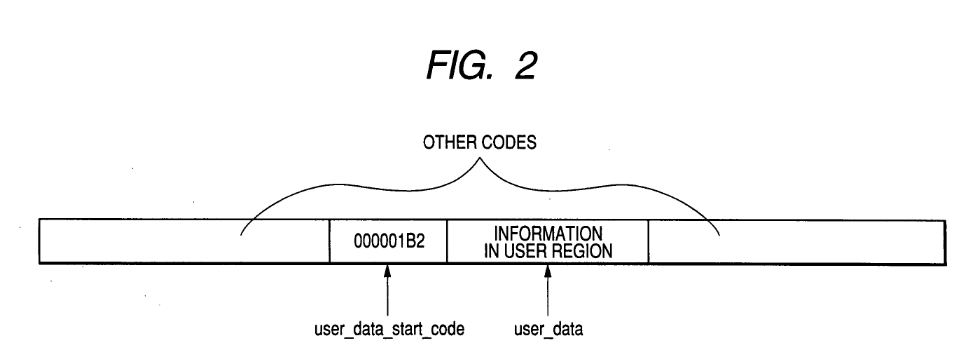

Hence, information from the encoder to the decoder, indicating that macro blocks to be inter-encoded among macro blocks forming one frame account for a ½ frame, is written into a user region within encoded data (bit stream) in the format shown in FIG. 2. FIG. 2 is a view showing a coding method for the user region defined by the MPEG standards.

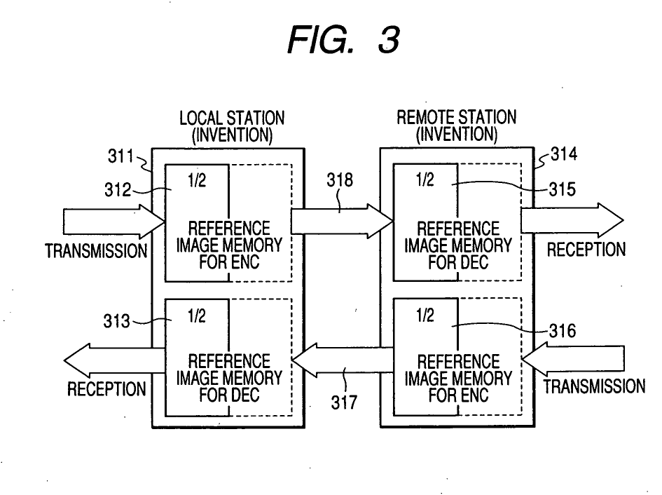

FIG. 3 is a view used to describe a use method of the reference image memories according to this embodiment. Referring to FIG. 3, numeral 311 denotes a motion picture coding apparatus in the local station, numeral 312 denotes a reference image memory that the encoder (ENC) uses when a transmission image is encoded in the local station, numeral 313 denotes a reference image memory that the decoder (DEC) uses when a reception image is decoded in the local station, numeral 314 denotes a motion picture coding apparatus in the remote station, numeral 315 denotes a reference image memory that the decoder (DEC) uses when a reception image is decoded in the remote station, and numeral 316 denotes a reference image memory that the encoder (ENC) uses when a transmission image is encoded in the remote station.

Further, numeral 318 denotes encoded data (bit stream) distributed to the motion picture coding apparatus 314 in the remote station from the motion picture coding apparatus 311 in the local station, and numeral 317 denotes encoded data (bit stream) distributed to the motion picture coding apparatus 311 in the local station from the motion picture coding apparatus 314 in the remote station.

The motion picture coding apparatus 311 in the local station performs coding by reducing a capacity of the reference image memory 312, which needs to be one frame's worth in the related art, to ½ frame's worth by the method of the precedent application art. In this instance, the motion picture coding apparatus 311 in the local station writes information, indicating that macro blocks to be inter-encoded among macro blocks forming one frame account for a ½ frame, into the user region within the encoded data in the format shown in FIG. 2.

By reading this information from the encoded data 318, the motion picture coding apparatus 314 in the remote station judges that inter-encoded macro blocks account for ½ of all the macro blocks, and performs encoding using the reference image memory 315 having a 1/2 frame's worth of capacity.

For example, for an image size for which the number of all macro blocks is 1200 (VGA), when inter-encoded macro blocks account for a ½ frame, then a capacity of the reference image memory needed for decoding is a capacity corresponding to 600 macro blocks.

Likewise, the motion picture coding apparatus 314 in the remote station performs encoding by reducing a capacity of the reference image memory 316 to ½ frame's worth, and writes information, indicating that macro blocks to be inter-encoded among macro blocks forming one frame account for a ½ frame, into the user region within the encoded data in the format shown in FIG. 2. Upon receipt of the encoded data 317 including such information, the motion picture coding apparatus 311 in the local station is able to perform decoding by reducing a capacity of the reference image memory 313 to ½ frame's worth.

As has been described, by informing the remote station that the macro blocks to be inter-encoded among macro blocks forming one frame account for a ½ frame in the form of information written in the user region within the encoded data, it is possible to reduce a total of a one frame's worth of capacity from the reference image memories in each of the local station and the remote station.

Further, in a case where the method of the invention is used in both the local station and the remote station, it is also possible to construct a system by fixing a capacity of each reference image memory to ½ frame's worth, instead of transmitting information indicating the ratio of the inter-encoded macro blocks using the user region within the encoded data. Alternatively, a capacity of each reference image memory may be set to ½ frame's worth from the outside.

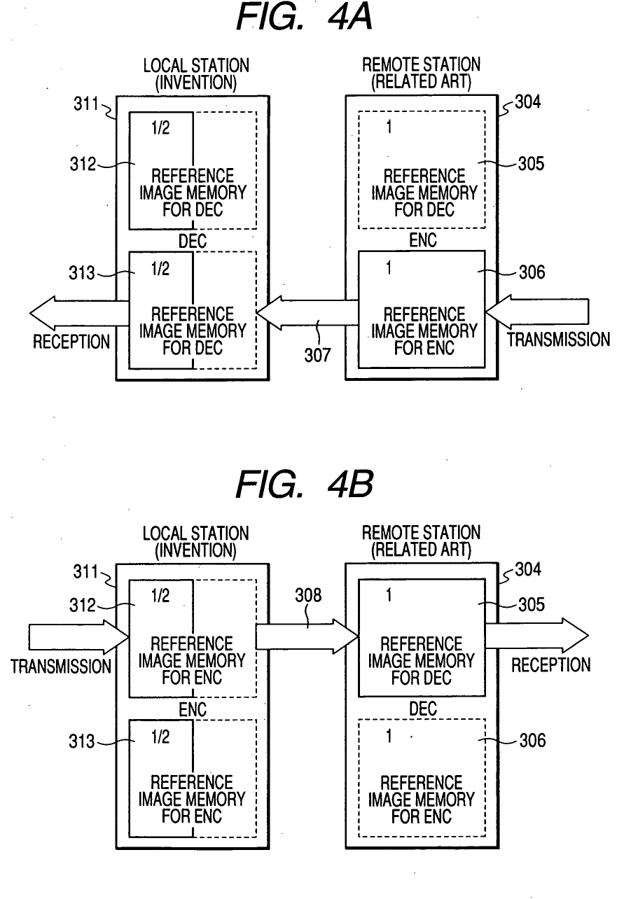

The method of reducing a capacity of the reference image memory in the precedent application art imposes limitations to the predicting coding that is the basis of the motion picture compression coding techniques. Hence, limitations are imposed when the local station adopting the method of the invention is to make a motion picture communication with the remote station adopting the method in the related art. For example, FIGS. 4A and 4B are views used to describe a use method of the reference image memories when a motion picture communication is made using the motion picture coding apparatus of this embodiment in the local station and the motion picture coding apparatus in the related art in the remote station.

FIG. 4A shows a case where the local station receives a motion picture from the remote station. The motion picture coding apparatus 304 in the remote station performs encoding using the reference image memory 306 having a one frame's worth of capacity. However, because the motion picture coding apparatus 311 in the local station has the reference image memory 313 having only a ½ frame's worth of capacity for decoding. This makes it impossible to decode a motion picture unless configured otherwise.

Because the motion picture coding apparatus 311 is unable to detect, in advance, a capacity of the reference image memory that the remote station will use for encoding, it judges that the remote station is a motion picture coding apparatus in the related art. The motion picture coding apparatus 311 then allocates the reference image memory 312 for encoding to a reference image memory for decoding, and performs decoding using the reference image memories 312 and 313 together as a reference image memory having a one frame's worth of capacity. This enables only a one-way communication. However, even the local station of this embodiment having reduced a capacity of the reference image memory to ½ is able to make a motion picture communication with the remote station in the related art.

FIG. 4B shows an inverse case where the local station transmits a motion picture to the remote station. The motion picture coding apparatus 311 in the local station performs encoding using the reference image memory 312 having a ½ frame's wroth of capacity. The motion picture coding apparatus 304 in the remote station performs decoding using the reference image memory 306 having a one frame's worth of capacity. In this instance, the reference image memory 306 actually uses only a half of the capacity.

This use method enables a motion picture communication. However, only a one-way communication is enabled due to the limitations described in the case of FIG. 4A. By taking it into account that the reference image memory 313 is available, the motion picture coding apparatus 311 is also able to perform coding using the reference image memories 312 and 313 together as a reference image memory having a one frame's worth of capacity in the case shown in FIG. 4B.

Generally, the method of reducing a capacity of the reference image memory in the precedent application art has to increase macro blocks to be intra-encoded, for which a predicting frame is not needed. Hence, it is a method potentially having a case where an encoding volume is increased as the result. Also, depending on the predetermined positions of macro blocks to be inter-encoded, it is also a method potentially having a case where detection accuracy of a motion vector is deteriorated, and an encoding volume is increased as the result. When these potential cases are accumulated, there may arise a case where an encoding volume exceeds a communication capacity. In such a case, a quantization coefficient is manipulated to reduce an encoding volume, which is always associated with deterioration in image quality.

Because the motion picture coding apparatus 311 is unable to detect, in advance, a capacity of the reference image memory that the remote station will use for decoding, it judges that the remote station is a motion picture coding apparatus in the related art. The motion picture coding apparatus 311 then allocates the reference image memory 312 for decoding, which is now available, to a reference image memory for encoding, and performs encoding using the reference image memories 312 and 313 together as a reference image memory for encoding having a one frame's worth of capacity. This makes it possible to secure a reference image memory equivalent to the reference image memory 306 having a one frame's worth of capacity in the motion picture coding apparatus 304 in the remote station, which can in turn improve the image quality. It is thus possible to prevent deterioration of the image quality when an encoding volume is increased.

### Second Embodiment

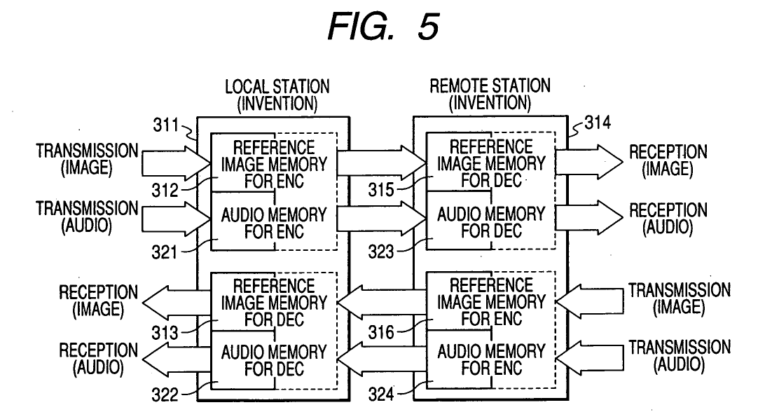

By further reducing capacities of the reference image memories prepared in the first embodiment for encoding and for decoding with each having a ½ frame's worth of capacity, it is possible to use an available memory region for another use. FIG. 5 is a view used to describe a use method of reference image memories and audio memories in a second embodiment. This embodiment is to perform control in such a manner that a capacity of the reference image memory is reduced further to be smaller than ½ frame's worth and to use a memory region thus made available as an audio memory space.

Referring to FIG. 5, numeral 321 denotes an audio memory for the encoder used to encode an audio in the local station, numeral 322 denotes an audio memory for the decoder used to decode an audio in the local station, numeral 323 denotes an audio memory for the decoder used to decode an audio in the remote station, and numeral 324 denotes an audio memory for the encoder used to encode an audio in the remote station. In this embodiment, a capacity of the reference image memory is reduced to ¼ frame's worth from ½ frame's worth, and a ¼ frame's worth of capacity thus made available is allocated to an audio memory.

That is to say, a capacity of the reference image memory 312 for encoding a motion picture in the local station is reduced to ¼ frame's worth, and a ¼ frame's worth of capacity thus made available is used as the audio memory 321 for the encoder. A capacity of the reference image memory 313 for decoding a motion picture in the local station is reduced to ¼ frame's worth, and a ¼ frame's worth of capacity thus made available is used as the audio memory 322 for the decoder in the local station. The same can be said in the remote station.

Because this configuration further reduces capacities of the reference image memories in comparison with the first embodiment, an encoding volume of encoded data of a motion picture is increased, and deterioration of the image quality is likely to occur. However, in a case where processing by the audio codec is not needed, the memory allocated to the audio memory can be re-allocated back to the original reference image memory. Also, in a case where the priority is placed on an audio rather than an image quality, a capacity of the reference image memory can be reduced further. As has been described, it is possible to set capacities of the reference image memory and the audio memory flexibly to best suit the system configuration and the purpose of use.

This embodiment described a case where a capacity of the reference image memory is reduced and a memory thus made available is allocated to the audio memory. However, the use of an available memory in this embodiment is not limited to the audio memory, and a memory made available by reducing a capacity of the reference image memory can be used for any other purpose. For example, an available memory can be used as a buffer memory of the CPU.

In addition, by allocating a memory made available by reducing a capacity of the reference image memory to a reference image memory for another motion picture encoding in this embodiment, it is possible to achieve a motion picture coding apparatus furnished with two sets of motion picture coding functions, that is, a multi-codec of a motion picture.

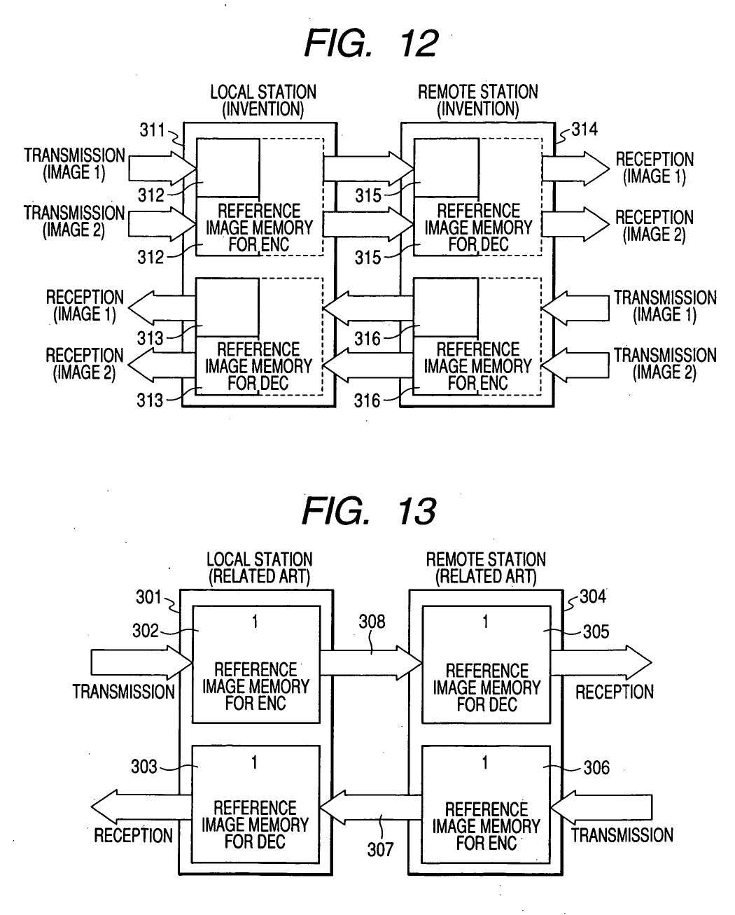

FIG. 12 shows a multi-codec of a motion picture configured as described above. Comparison with the configuration in FIG. 5 reveals that the audio memories 321 and 324 for the encoder correspond, respectively, to reference image memories 312 and 316 for second motion picture encoding, and the sound memories 322 and 323 for the decoder correspond, respectively, to reference image memories 313 and 315 for second motion picture decoding.

That is to say, a capacity of the reference image memory 312 for first motion picture encoding in the local station is reduced to ¼ frame's worth, and a ¼ frame's worth of capacity thus made available is used as the reference image memory 312 for second motion picture encoding. A capacity of the reference image memory 313 for decoding a motion picture in the local station is reduced to ¼ frame's worth, and a ¼ frame's worth of capacity thus made available is used as the reference image memory 313 for second motion picture encoding. The same can be said in the remote station.

As has been described, the image quality of a motion picture to be transmitted and received is limited because a capacity of each reference image memory is reduced to ¼ frame's worth. However, it is possible to achieve a multi-codec of a motion picture without the need to increase a memory capacity from a capacity achieved in the first embodiment, that is, ½ frame's worth.

In the description above, the multi-codec of a motion picture is furnished with two sets of motion picture coding functions, and a region of each reference image memory is a ¼ of one frame. However, these configurations are given for ease of explanation, and it is possible to achieve a multi-codec of a motion picture having an arbitrary number of sets when limitations on an image quality of a motion picture are acceptable.

As has been described, according to this embodiment, in a two-way communication using the motion picture coding method of the invention in both the local station and the remote station, it is possible to use a memory in various forms depending on the purpose of use of the system while reducing a total capacity of the memories by controlling a ratio of a capacity of the reference image memory and a capacity of a memory for another purpose of use.

### Third Embodiment

Even under communication circumstances where an image quality is deteriorated by sharing reference image memories, prepared in the first embodiment for encoding and decoding with each having a ½ frame's worth of capacity, between the encoder and the decoder depending on the situation, it is possible to utilize reference image memories having a limited capacity for the image quality to be improved.

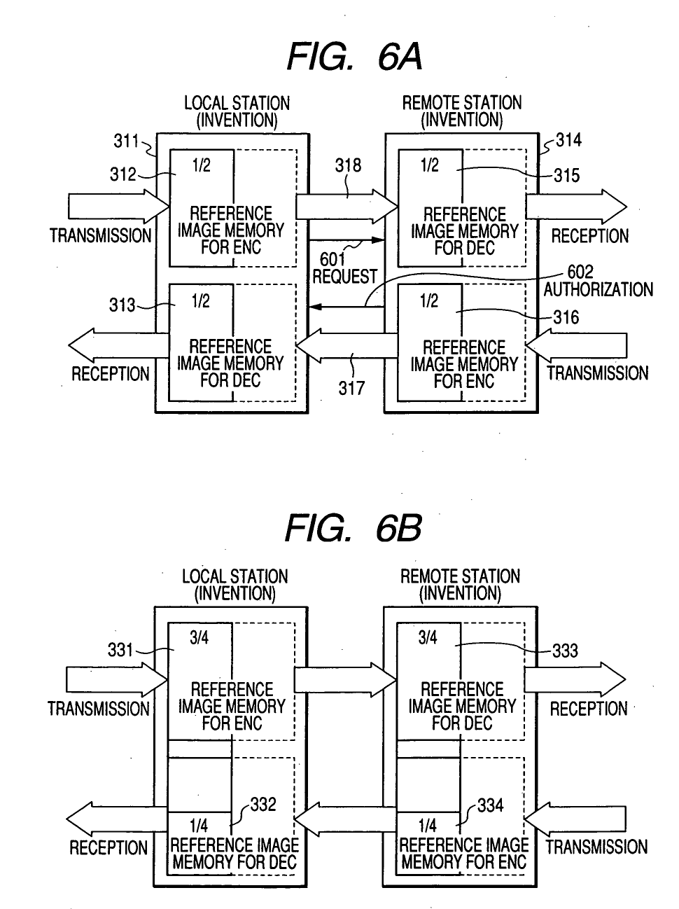

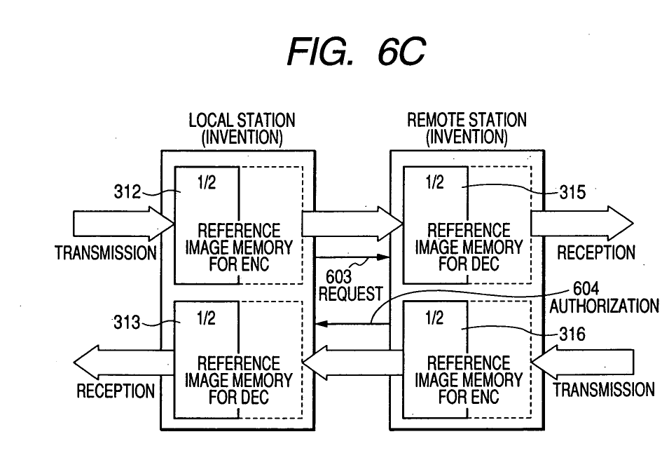

In a third embodiment, to enable the encoder and the decoder to share the reference image memories depending on the situation, the local station and the remote station exchange a request and an authorization response to share the reference image memories, using the coding method of the user region shown in FIG. 2. FIG. 6A through FIG. 9 are views used to show a use method of the reference image memories in the third embodiment.

FIG. 6A to 6C show a method of increasing a capacity of the reference image memory in the encoder in the local station and making a request to increase a capacity of the reference image memory in the decoder in the remote station when the user judges that it is necessary to improve an image quality of an image to be transmitted from the local station to the remote station. For example, this embodiment can be used in a case where a presentation is made from the local station to the remote station using a two-way motion picture communication, and the user wishes to improve an image quality to be transmitted to the remote station to advertise the product on the local station side.

Referring to FIG. 6A, when the user judges that the image quality of a transmission image from the local station to the remote station needs to be improved for the reason described above while the motion picture coding apparatus 311 in the local station and the motion picture coding apparatus 314 in the remote station are making a two-way motion picture communication in the same manner as the first embodiment, the motion picture coding apparatus 311 in the local station transmits a request 601 to increase a capacity of the reference image memory in the decoder to the motion picture coding apparatus 314 in the remote station, using the user region within the encoded data. Herein, the request is to increase a capacity of the reference image memory to ¾ frame's worth from ½ frame's worth; however, an increase in capacity is not limited to this quantity in embodiments of the invention.

Upon judging that it is possible to increase a capacity of the reference image memory, the motion picture coding apparatus 314 in the remote station transmits an authorization response 602 to the motion picture coding apparatus 311 in the local station using the user region within the encoded data, while increasing a capacity of the reference image memory in the decoder to ¾ frame's worth from ½ frame's worth.

Upon receipt of the authorization response 602, the motion picture coding apparatus 311 in the local station increases a capacity of the reference image memory in the encoder to ¾ frame's worth from ½ frame's worth. Capacities of both of the reference image memories used to transmit a motion picture from the local station to the remote station can be thus increased to ¾ frame's worth from ½ frame's worth. At the same time, capacities of both of the reference image memories used to transmit a motion picture from the remote station to the local station are reduced to ¼ frame's worth from ½ frame's worth.

As a result, the use states of the reference image memories are as the one shown in FIG. 6B, that is, the encoder in the local station is able to use a region 331 of a ¾ frame as the reference image memory, and the decoder in the remote station is able to use a region 333 of a ¾ frame as the reference image memory. At the same time, the reference image memory that the decoder in the local station is allowed to use is limited to a region 332 of a ¼ frame, and the reference image memory that the encoder in the remote station is allowed to use is limited to a region 334 of a ¼ frame.

It is thus possible to improve the image quality of a motion picture transmitted from the local station to the remote station whereas the image quality of a motion picture received at the local station from the remote station is deteriorated. In this manner, by biasing the image quality in a two-way motion picture communication to one way, the image quality of a motion picture transmitted from the local station can be improved by the sacrifice of the image quality of a motion picture received from the remote station.

In order to restore the image qualities in the both ways to be equal after such a state has continued as long as necessary, a request 603 to restore a capacity of the reference image memory in the decoder is transmitted from the motion picture coding apparatus 311 in the local station to the motion picture coding apparatus 314 in the remote station, using the user region within the encoded data. Upon receipt of the request 603, the motion picture coding apparatus 314 in the remote station restores the capacity of the reference image memory in the decoder to an original ½ frame's worth of capacity, while returning an authorization response 604 to the motion picture coding apparatus 311 in the local station. Upon receipt of the authorization response 604, the motion picture coding apparatus 311 in the local station restores the capacity of the reference image memory in the encoder to an original ½ frame's worth of capacity. The use states of the reference image memories are returned to the initial states as is shown in FIG. 6C. In addition, according to this embodiment, when the user wishes to reduce capacities of the reference image memories needed when a transmission image from the local station to the remote station is encoded, the reference image memory in the encoder in the local station can be reduced and a request to reduce a capacity of the reference image memory in the decoder in the remote station can be transmitted in the same manner as above.

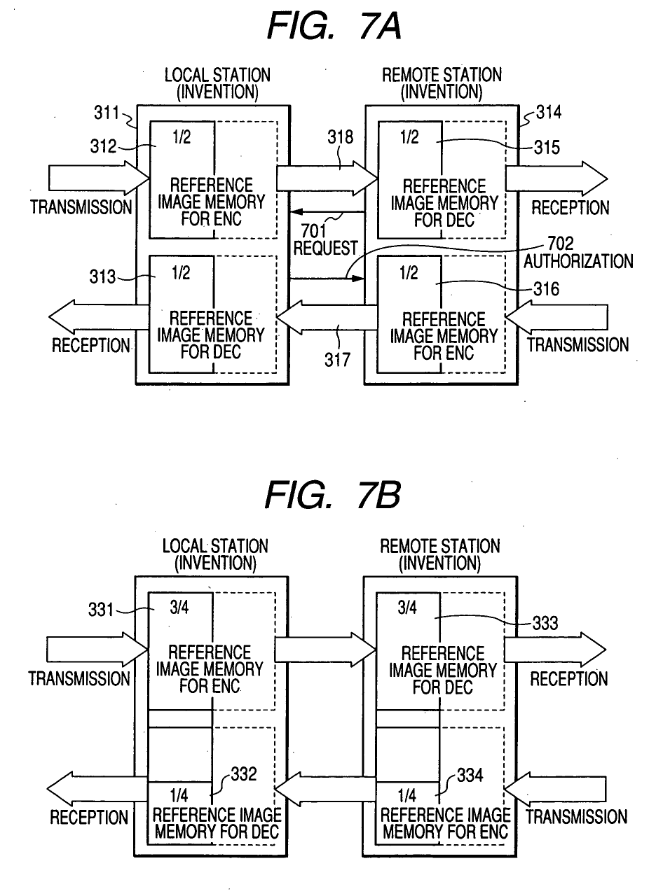

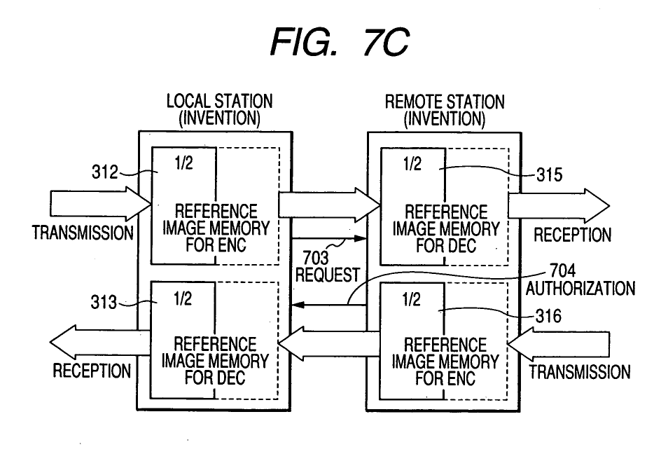

Conversely to the above case, when the user judges that the image quality of a reception image at the local station needs to be improved, the processing of this embodiment can be performed by transmitting a request to share the reference image memories from the remote station to the local station and receiving an authorization response. FIGS. 7A to 7C show a method of increasing a capacity of the reference image memory in the decoder in the remote station and transmitting a request to increase a capacity of the reference image memory in the encoder in the local station when the user judges that the image quality of a reception image at the remote station needs to be increased.

Referring to FIG. 7A, when the user judges that the image quality of a reception image at the remote station needs to be increased while the motion picture coding apparatus 311 in the local station and the motion picture coding apparatus 314 in the remote station are making a two-way motion picture communication in the same manner as the first embodiment, the motion picture coding apparatus 314 in the remote station transmits a request 701 to increase a capacity of the reference image memory in the encoder to the motion picture coding apparatus 311 in the local station, using the user region within the encoded data. Herein, the request is to increase a capacity of the reference image memory to ¾ frame's worth from ½ frame's worth; however, an increase in capacity is not limited to this quantity in embodiments of the invention.

Upon judging that it is possible to increase a capacity of the reference image memory in the encoder, the motion picture coding apparatus 311 in the local station transmits an authorization response 702 to the motion picture coding apparatus 314 in the remote station, using the user region within the encoded data, and increases a capacity of the reference image memory in the encoder to ¾ frame's worth from ½ frame's worth.

Upon receipt of the authorization response 702, the motion picture coding apparatus 314 in the remote station increases a capacity of the reference image memory in the decoder to ¾ frame's worth from ½ frame's worth. It is thus possible to increase the capacities of both of the reference image memories used to transmit a motion picture from the local station to the remote station to ¾ frame's worth from ½ frame's worth. At the same time, capacities of both of the reference image memories used to transmit a motion picture from the remote station to the local station are reduced to ¼ frame's worth from ½ frame's worth.

As a result, the use states of the reference image memories are as the one shown in FIG. 7B, which are the same as the use states of the reference image memories in FIG. 6B. Hence, the image quality of a motion picture transmitted from the local station to the remote station can be improved whereas the image quality of a motion picture received at the local station from the remote station is deteriorated. As has been described, by biasing the image quality in a two-way motion picture communication to one way, it is possible to improve the image quality of a motion picture received at the remote station from the local station by the sacrifice of the image quality of a motion picture transmitted from the remote station.

In order to restore the image qualities in the both ways to be equal after such a state has continued as long as necessary, a request 703 to restore a capacity of the reference image memory in the encoder is transmitted from the motion picture coding apparatus 314 in the remote station to the motion picture coding apparatus 311 in the local station, using the user region within the encoded data. Upon receipt of the request 703, the motion picture coding apparatus 311 in the local station restores the capacity of the reference image memory in the encoder to an original ½ frame's worth of capacity and returns an authorization response 704 to the motion picture coding apparatus 314 in the remote station. Upon receipt of the authorization response 704, the motion picture coding apparatus 314 in the remote station restores the capacity of the reference image memory in the decoder to an original ½ frame's worth of capacity. The use states of the reference image memories are thus returned to the initial states as is shown in FIG. 7C.

In this embodiment, by fully sharing the reference image memories, prepared in the local station and the remote station with each having a ½ frame's worth of capacity, between the encoder and the decoder, the encoder in the local station is allowed to use the reference image memories having a one frame's worth of capacity in total while the decoder in the remote station is allowed to use the reference image memories having a one frame's worth of capacity in total, which makes it possible to improve the image quality to the maximum level in this embodiment. In this case, a one-way communication form the local station to the remote station is enabled. In addition, according to this embodiment, when the user wishes to reduce capacities of the reference image memories needed when a reception image is decoded in the remote station, a capacity of the reference image memory in the decoder in the remote station can be reduced and a request to reduce the reference image memory in the encoder in the local station can be transmitted in the same manner as above.

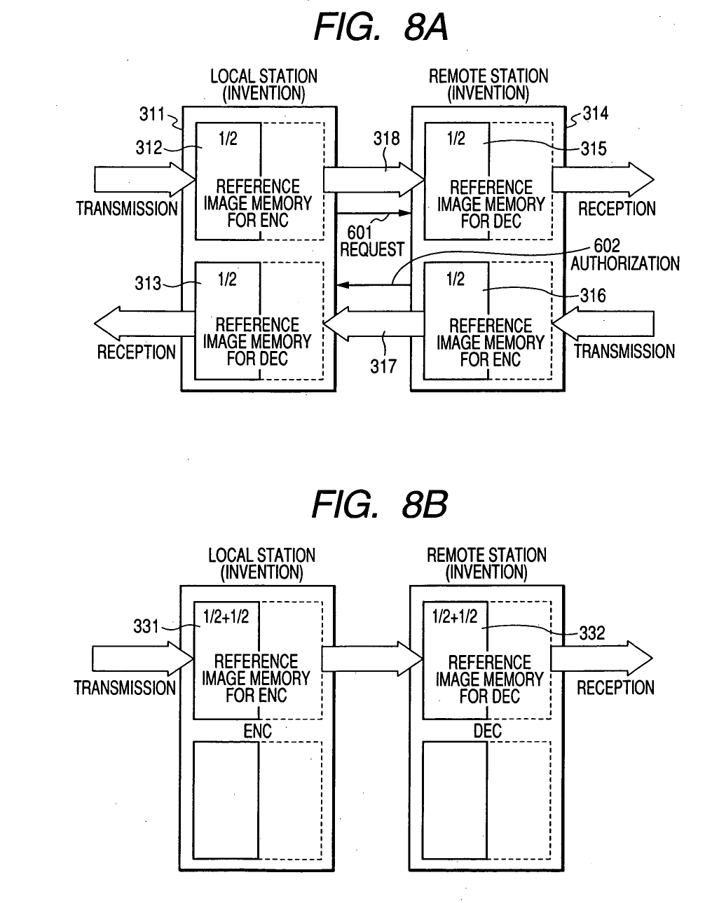

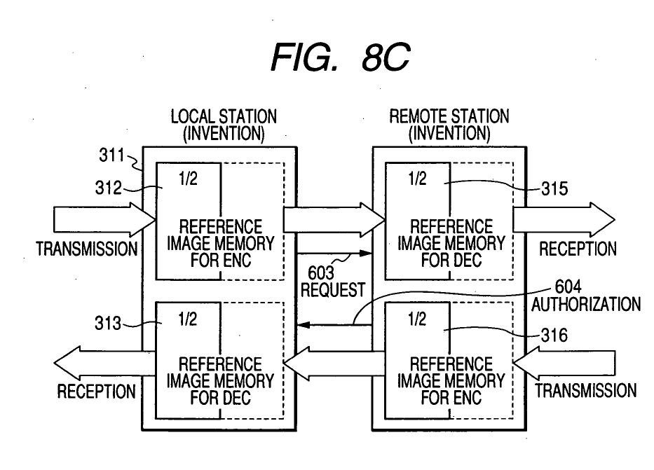

FIGS. 8A to 8C show a method of increasing a capacity of the reference image memory in the encoder in the local station to one frame's worth while making a request to increase a capacity of the reference image memory in the decoder in the remote station to one frame's worth in order to improve the image quality of a transmission image from the local station to the remote station. When configured in this manner, although only a one-way communication is enabled temporarily, the image quality can be improved during the one-way communication.

FIGS. 8A, 8B, and 8C correspond to FIGS. 6A, 6B, and 6C, respectively, and the configurations are the same as those in FIGS. 6A to 6C, except that each of the reference image memory 331 that the encoder in the local station uses and the reference image memory 333 that the decoder in the remote station uses has a one frame's worth of capacity, and capacities of both of the reference image memory 332 that the decoder in the local station uses and the reference image memory 334 that the encoder in the remote station uses are reduced to0 (nil). In addition, because the processing method is the same, too, descriptions for FIGS. 8A to 8C are omitted herein.

When the local station of the invention and the remote station in the related art make a motion picture communication, as has been described in the first embodiment, it is necessary to match the capacities of the reference image memories that the encoder and the decoder in the local station use with those in the related art. This poses a limitation that only a one-way communication is enabled. However, in a case where the remote station in the related art is an apparatus adopting an image smaller than that in the local station and the local station is able to detect this condition in advance, there is a possibility to maintain a two-way communication by the processing according to this embodiment.

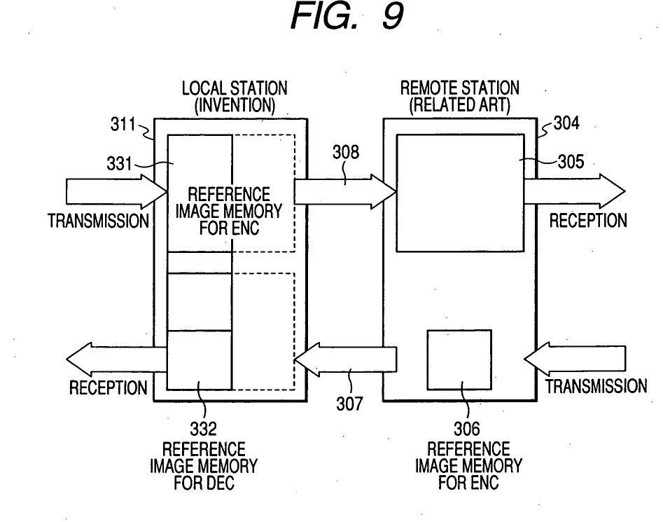

FIG. 9 is a view used to describe a use method of the reference image memories in a case where the local station of the invention makes a motion picture communication with the remote station in the related art adopting an image smaller than that in the local station. The reference image memory 305 having a one frame's worth of capacity that the decoder in the motion picture coding apparatus 304 in the remote station in FIG. 9 uses is smaller than the reference image memory 305 having a one frame's worth of capacity that the decoder in the motion picture coding apparatus 304 in FIG. 4B uses. The reference image memory 306 having a one frame's worth of capacity that the encoder in the motion picture coding apparatus 304 in the remote station in FIG. 9 uses is smaller than the reference image memory 306 having a one frame's worth of capacity that the encoder in the motion picture coding apparatus 304 in FIG. 4A uses.

Under these circumstances, in a case where a total memory capacity of the reference image memory 305 and the reference image memory 306 in the motion picture coding apparatus 304 in the remote station is equal to or smaller than a total memory capacity of the reference image memory 331 and the reference image memory 332 in the motion picture coding apparatus 311 in the local station, when the local station is able to obtain this information in advance, it is possible to maintain a two-way communication by sharing the reference image memories in the local station between the encoder and the decoder as is shown in FIG. 9.

### Fourth Embodiment

The method of reducing capacities of the reference image memories, which is the characteristic of the invention, has to increase macro blocks to be intra-encoded for which the predicting frame is not needed, and it is therefore a method that potentially has a case where an encoding volume is increases as the result. This method, therefore, often has a risk that an encoding volume exceeds a communication capacity, and intrinsically has a defect that the image quality is readily deteriorated in order to reduce an encoding volume.

The method of improving the image quality by sharing the reference image memories between the encoder and the decoder according to the third embodiment is to exchange a request to share the reference image memories and an authorization response between the local station and the remote station according to the judgment made by the user depending on the situation. The defect specified above can be overcome by automatically performing the same processing as that in the third embodiment when an encoding volume to be transmitted and received exceeds a predetermined level.

In a fourth embodiment, an encoding volume counter to observe an encoding volume to be transmitted from the local station or the remote station and an encoding volume to be received at the local station or the remote station is provided, so that a request to share the reference image memories and an authorization response are exchanged between the local station and the remote station when the value in the encoding volume counter exceeds a predetermined level.

In the configuration of the motion picture coding apparatus of FIG. 1, numeral 132 denotes an encoding volume counter provided to observe an encoding volume at the transmitter's end or an encoding volume of encoded data at the receiver's end. The CPU 131 monitors the value of the encoding volume counter 132, and when the value exceeds the predetermined level, it sends a command to the variable-length coding portion 105 to use the user region within the encoded data for a request to share the reference image memories and an authorization response to be exchanged between the local station and the remote station.

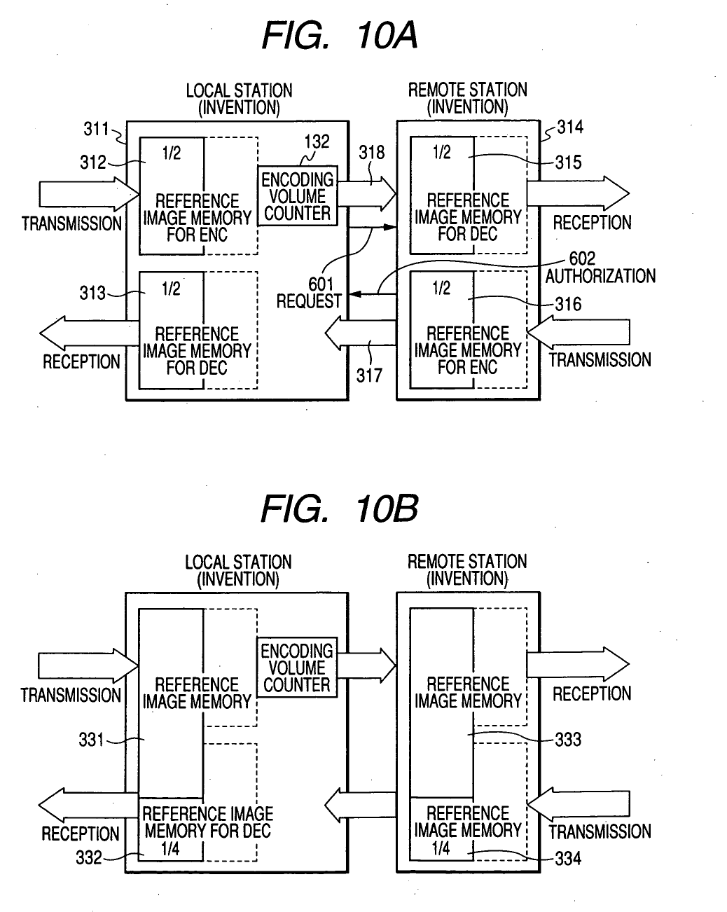

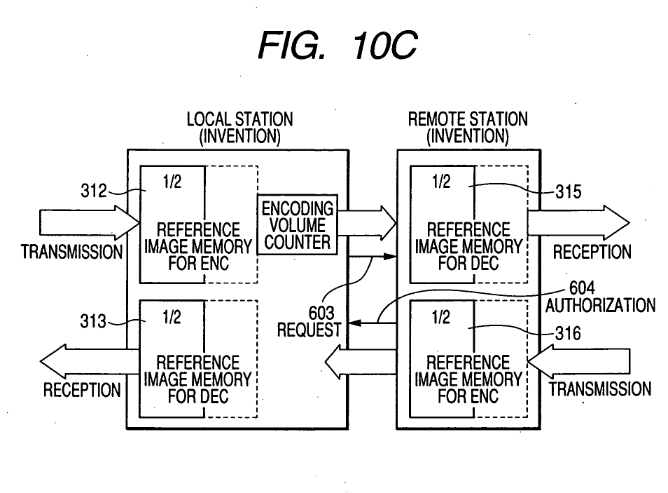

FIGS. 10A to 10C are views showing a method of increasing a capacity of the reference image memory in the encoder in the local station while making a request to increase a capacity of the reference image memory in the decoder in the remote station when the value of the encoding volume counter exceeds the predetermined level while an encoding volume of encoded data to be transmitted from the local station is being observed.

The configuration of FIGS. 10A to 10C are the same as the configuration of FIGS. 6A to 6C except that an encoding volume of encoded data to be transmitted from the motion picture coding apparatus 311 in the local station is observed by the encoding volume counter 132. In addition, because operations are the same as those of FIGS. 6A to 6C, too, descriptions of FIGS. 10A to 10C are omitted herein.

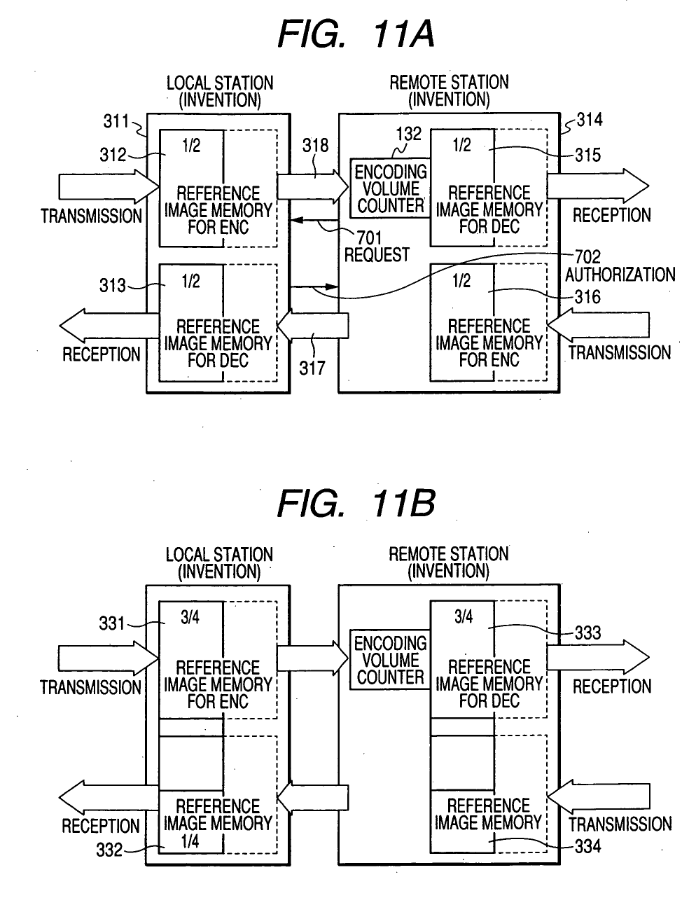

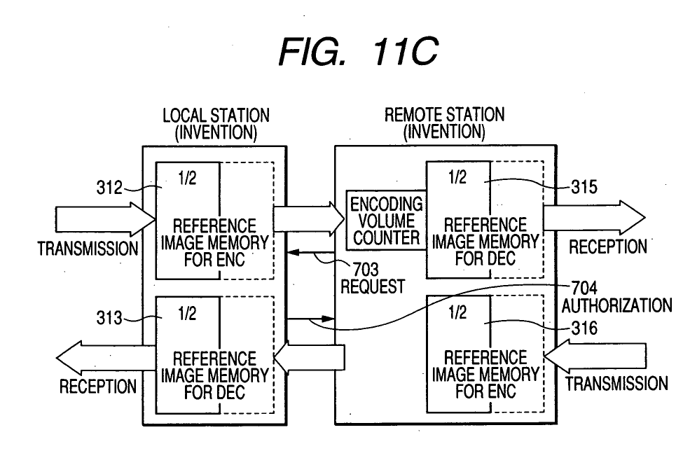

FIGS. 11A to 11C are views showing a method of increasing a capacity of the reference image memory in the decoder in the remote station and making a request to increase a capacity of the reference image memory in the encoder in the local station when the value of the encoding volume counter exceeds the predetermined level while an encoding volume of encoded data to be received at the remote station is being observed.

The configuration of FIGS. 11A to 11C are the same as the configuration of FIGS. 7A to 7C except that an encoding volume of encoded data to be received at the motion picture coding apparatus 314 in the remote station is observed by the encoding volume counter 132. In addition, because operations are the same as those of FIGS. 7A to 7C, too, descriptions of FIGS. 11A to 11C are omitted herein.

It should be noted, however, that when an encoding volume is increased markedly due to an abrupt scene change, even capacities of the reference image memories to be used are controlled between the local station and the remote station according to this embodiment, it may be difficult to transmit and receive a motion picture at the image quality within an allowable range.

When an encoding volume exceeds the performance of a mobile device, including the performance of a communication path, it may be better not to perform useless control to avoid a use such that makes the user feel unnatural. In this embodiment, when an encoding volume observed by the encoding volume counter is increased to exceed the acceptable limit, it is possible not to perform the processing described above.

Further, whether the processing is to be performed can be selected and specified from the outside. Furthermore, the function may be extended in such a manner that the processing is performed when a state where an encoding volume exceeds the acceptable limit and keeps increasing for a predetermined number of frames or more. In this case, attentions should be paid, because the image quality varies frequently when the predetermine number of frames is small.

As has been described, according to this embodiment, by observing an encoding volume using the encoding volume counter provided at the transmitter's end or the receiver's end, and changing capacities of the reference image memories between the local station and the remote station as needed depending on the observed encoding volume, it is possible to suppress deterioration of the image quality in a situation where an encoding volume exceeds a communication capacity.

The motion picture coding method and apparatus of the invention can reduce a capacity of the reference image memory and thereby achieve the codec function of performing compression and decompression of one or more than one image or audios concurrently, and are therefore useful for use in TV conference system, etc. In addition, they can be applied for use in a TV telephone using a cellular phone with camera.

1. A motion picture coding method in a system performing a two-way motion picture communication, comprising:
placing oppositely two pieces of motion picture coding apparatus that encode and decode a motion picture by a motion picture compression coding method using reference image memories constructed in such a manner that memory capacities are sharable between a reference image memory used for encoding and a reference image memory used for decoding; and
determining a capacity of the reference image memory used for encoding depending on a capacity of the reference image memory used for decoding.

2. The motion picture coding method according to claim 1, wherein oppositely placed first and second pieces of motion picture coding apparatus exchange capacity control information of the reference image memory each piece uses.

3. The motion picture coding method according to claim 2, wherein the capacity control information is exchanged using user information embedded in a bit stream of encoded data of a motion picture.

4. The motion picture coding method according to claim 2, wherein the capacity control information of the reference image memory is control information allowing the second piece of motion picture coding apparatus to detect, in advance, a capacity of the reference image memory that the first piece of motion picture coding apparatus uses for encoding.

5. The motion picture coding method according to claim 4, wherein in a case where the capacity of the reference image memory that the first piece of motion picture coding apparatus uses for encoding is detectable in advance, a capacity of the reference image memory that the second piece of motion picture coding apparatus uses for decoding is set equal to the capacity of the reference image memory that the first piece of motion picture coding apparatus uses for encoding.

6. The motion picture coding method according to claim 4, wherein in a case where the capacity of the reference image memory that the first piece of motion picture coding apparatus uses for encoding is undetectable in advance, a capacity of the reference image memory that the second piece of motion picture coding apparatus uses for decoding is set equal to a capacity of the reference image memory defined in the system performing the two-way motion picture communication.

7. The motion picture coding method according to claim 2, wherein the capacity control information of the reference image memory is control information allowing the second piece of motion picture coding apparatus to detect, in advance, a capacity of the reference image memory that the first piece of motion picture coding apparatus uses for decoding.

8. The motion picture coding method according to claim 7, wherein in a case where the capacity of the reference image memory that the first piece of motion picture coding apparatus uses for decoding is detectable in advance, a capacity of the reference image memory that the second piece of motion picture coding apparatus uses for encoding is set equal to the capacity of the reference image memory that the first piece of motion picture coding apparatus uses for decoding.

9. The motion picture coding method according to claim 7, wherein in a case where the capacity of the reference image memory that the first piece of motion picture coding apparatus uses for decoding is undetectable in advance, a capacity of the reference image memory that the second piece of motion picture coding apparatus uses for encoding is set equal to a capacity of the reference image memory defined in the system performing the two-way motion picture communication.

10. The motion picture coding method according to claim 1, wherein a capacity of the reference image memory used for encoding or decoding is set in advance from an outside.

11. The motion picture coding method according to claim 10, wherein in a case where a capacity of the reference image memory used for encoding or decoding is set to a capacity smaller than a memory capacity usable as the reference image memory, an available memory capacity in the usable memory capacity as the reference image memory is used for another purpose other than the reference image memory.

12. The motion picture coding method according to claim 11, wherein the available memory capacity in the usable memory capacity as the reference image memory is used for encoding and decoding audios.

13. The motion picture coding method according to claim 2, wherein the capacity control information of the reference image memory is control information allowing the first piece of motion picture coding apparatus to make a request to the second piece of motion picture coding apparatus to increase or decrease a capacity of the reference image memory used for encoding, or control information allowing the first piece of motion picture coding apparatus to make a request to the second piece of motion picture coding apparatus to restore the increased or decreased capacity of the reference image memory to a capacity before the capacity was increased or decreased.

14. The motion picture coding method according to claim 13, wherein the control information requesting to increase or decrease the capacity of the reference image memory used for encoding, or the control information requesting to restore the increased or decreased capacity of the reference image memory to a capacity before the capacity was increased or decreased is transmitted in the form of a manipulation signal from an outside in the first piece of motion picture coding apparatus.

15. The motion picture coding method according to claim 13, wherein the control information requesting to increase the capacity of the reference image memory used for encoding, or the control information requesting to restore the increased capacity of the reference image memory to a capacity before the capacity was increased is transmitted when an encoding volume of encoded data to be received at the first piece of motion picture coding apparatus exceeds a predetermined value.

16. The motion picture coding method according to claim 13, wherein the control information requesting to increase the capacity of the reference image memory used for encoding, or the control information requesting to restore the increased capacity of the reference image memory to a capacity before the capacity was increased is transmitted when an encoding volume of encoded data to be received at the first piece of motion picture coding apparatus keeps exceeding a predetermined value for a predetermined number of plural frames.

17. The motion picture coding method according to claim 2, wherein the capacity control information of the reference image memory is control information allowing the first piece of motion picture coding apparatus to make a request to the second piece of motion picture coding apparatus to increase or decrease a capacity of the reference image memory used for decoding, or control information allowing the first piece of motion picture coding apparatus to make a request to the second piece of motion picture coding apparatus to restore the increased or decreased capacity of the reference image memory to a capacity before the capacity was increased or decreased.

18. The motion picture coding method according to claim 17, wherein the control information requesting to increase or decrease the capacity of the reference image memory used for decoding, or the control information requesting to restore the increased or decreased capacity of the reference image memory to a capacity before the capacity was increased or decreased is transmitted in the form of a manipulation signal from an outside in the first piece of motion picture coding apparatus.

19. The motion picture coding method according to claim 17, wherein the control information requesting to increase the capacity of the reference image memory used for decoding, or the control information requesting to restore the increased capacity of the reference image memory to a capacity before the capacity was increased is transmitted when an encoding volume of encoded data to be transmitted from the first piece of motion picture coding apparatus exceeds a predetermined value.

20. The motion picture coding method according to claim 17, wherein the control information requesting to increase the capacity of the reference image memory used for decoding, or the control information requesting to restore the increased capacity of the reference image memory to a capacity before the capacity was increased is transmitted when an encoding volume of encoded data to be transmitted from the first piece of motion picture coding apparatus keeps exceeding a predetermined value for a predetermined number of plural frames.

21. A motion picture coding apparatus, two pieces of which are placed oppositely to encode and decode a motion picture in a system performing a two-way motion picture communication by a motion picture compression coding method using reference image memories, wherein:
a reference image memory used for encoding and a reference image memory used for decoding are constructed as a common memory whose memory capacity is sharable;
the apparatus is controlled in such a manner that a capacity of the reference image memory used for decoding is allocated with a higher priority than a capacity of the reference image memory used for encoding; and
the apparatus is provided with communications means comprising transmission of a request and a transmission of a response to the request for enabling the oppositely placed two pieces of motion picture coding apparatus to exchange capacity control information of the reference image memory each piece uses.

22. A motion picture coding apparatus, two pieces of which are placed oppositely to encode and decode a motion picture in a system performing a two-way motion picture communication by a motion picture compression coding method using reference image memories, wherein:
a reference image memory used for encoding and a reference image memory used for decoding are constructed as a common memory whose memory capacity is sharable;
the apparatus is controlled in such a manner that a capacity of the reference image memory used for decoding is allocated with a higher priority than a capacity of the reference image memory used for encoding; and
the apparatus is provided with communications means comprising transmission of a request and a transmission of a response to the request for enabling the oppositely placed two pieces of motion picture coding apparatus to exchange capacity control information of the reference image memory each piece uses, wherein the apparatus performs the motion picture coding method according to claim 3.

23. The motion picture coding apparatus according to claim 21, wherein the apparatus is provided with an encoding volume counter that observes an encoding volume of encoded data to be received or an encoding volume of encoded data to be transmitted.

24. The motion picture coding apparatus according to claim 23, wherein whether the encoding volume counter observes the encoding volume of encoded data is set from an outside, and the encoding volume counter is deactivated when set not to observe the encoding volume.

25. The motion picture coding apparatus according to claim 21, wherein each of a capacity of the reference image memory used for encoding and a capacity of the reference image memory used for decoding is a capacity equal to or smaller than a memory capacity needed to store one frame of a reference image.

26. The motion picture coding apparatus according to claim 21, wherein each of a capacity of the reference image memory used for encoding and a capacity of the reference image memory used for decoding is divided into an equal number of plural sets, so that the apparatus functions as plural sets of motion picture coding apparatus.

27. The motion picture coding apparatus according to claim 21, wherein when a partial or entire region in the reference image memory is detected to be unused, the apparatus performs control in such a manner that the unused region is deactivated dynamically.

28. A two-way motion picture communication system performing the motion picture coding method according to claim 1.
